(19) United States
(12) Patent Application Publication
(10) Pub. No.: US 2017/0270249 A1
(43) Pub. Date: Sep. 21, 2017

(54) CLOUD STORAGE OF MEDICAL TEST RESULTS

(71) Applicant: SlipChip Corporation, Chicago, IL (US)

(72) Inventors: Timothy Beerling, Mill Valley, CA (US); Thomas H. Cauley, III, Redwood City, CA (US); Sobha Pisharody, Castro Valley, CA (US); Feng Shen, San Jose, CA (US)

(21) Appl. No.: 15/070,957

(22) Filed: Mar. 15, 2016

(51) Int. Cl. G06F 19/00; H04L 29/06

(52) U.S. Cl. CPC G06F 19/322; H04L 63/08; G06Q 2220/00

(57) ABSTRACT

A health record system is described that utilizes a data transfer methodology for transmitting and storing medical test results of patients of a health clinic that avoids the use of complex IT environments. The health record system performs medical tests using medical instrumentation devices located at a health clinic that lacks connectivity to a network. The results of the medical test are printed in the form of a visual code that is non-human readable. A client device scans the visual code and the results of the medical test are extracted from the visual code and sent to a cloud environment for storage when the client device has network connectivity.

### TECHNICAL FIELD

The embodiments disclosed herein generally relate to secure transfer of data from a medical instrumentation device to a cloud computing environment.

### BACKGROUND

Health clinics include medical instrumentation devices (otherwise known as point-of-care (POC) instrumentation). The medical instrumentation devices are used to conduct medical tests on patients at the health clinics. A glucose meter is one example of a medical instrumentation device.

Results of patients' medical tests are confidential information, and should not be widely distributed. Given the confidential nature of medical test results, health information privacy requirements have been established to maintain the confidentiality of medical test results. In order to meet the privacy requirements, conventional systems use a complex information technology (IT) environment to ensure that the medical test results are transmitted and stored in an electronic health record system of a health clinic in a reliable manner. However, in IT challenged environments it is difficult to establish the complex IT environments that are required to securely transmit and store confidential information of patients such as medical test results. Examples of IT challenged environments are:
Health clinics in the developing world. These clinics can range from hospitals with limited modern IT resources to mobile field testing wherein all equipment is brought along and set up in a tent or outside;
Health clinics in the developed world with limited IT resources. These clinics can be single physician offices or small group practices. It is very common for single or small group practices to turn to Software as a Service (SAS) to manage many of their IT needs;
On-site testing at places such as at schools, work places, or health events; and
A health clinic that lacks adequate wired network support.

### SUMMARY

A health record system is described that utilizes a data transfer methodology for securely transmitting and storing medical test data for health clinic patients. The described system avoids the use of complex IT environments that use network topologies requiring local IT support. The health record system performs medical tests using medical instrumentation devices located at a health clinic that lacks connectivity to a network. Given that the health clinic may lack network connectivity, the test data of the medical test cannot be directly uploaded to an electronic health record server that stores test results of patients of the health clinic.

Rather, the test data of the medical test are printed in the form of a visual code that is non-human decipherable. The visual code may also be displayed on the medical instrumentation device that generated the test data. The visual code may have a human readable representation (e.g. bar codes with numbers below the machine readable portion). However, the test data are encrypted such that it is impossible for a human to decipher the readable representation into meaningful data.

The test data can be uploaded to a cloud electronic health record server by using a client device of a user to scan the visual code when the client device has network connectivity. The visual code can be scanned directly from the display screen of the medical instrumentation device or from the printed medical test results. Responsive to scanning the visual code, the client device extracts the test data from the visual code and transmits the extracted results to the electronic health record server for storage. Alternatively, the client device transmits the visual code to the electronic health record server and the electronic health record server extracts the test data from the visual code. The embodiments described herein allow the health record system to be implemented in challenged environments that lack complex IT environments thereby ensuring the privacy of the patients of the health clinics.

The features and advantages described in this summary and the following detailed description are not all inclusive. Many additional features and advantages will be apparent to one of ordinary skill in the art in view of the drawings, specification and claims.

### BRIEF DESCRIPTION OF THE DRAWINGS

FIG. 1 illustrates a system architecture of a health record system in accordance with one embodiment.

FIG. 2 is a medical test result displayed on a medical instrumentation device according to one embodiment.

FIG. 3 illustrates an encrypted medical test result displayed on a client device according to one embodiment.

FIG. 4 is a graphical user interface (GUI) of a login screen of a decrypting cloud electronic health record server according to one embodiment.

FIG. 5 illustrates a GUI for displaying medical test results provided by the decrypting cloud electronic health record server according to one embodiment.

FIG. 6 is an interaction diagram for securely transmitting results of a medical test in the health record system shown in FIG. 1 according to one embodiment.

FIG. 7 illustrates a computer system that implements the embodiments herein according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

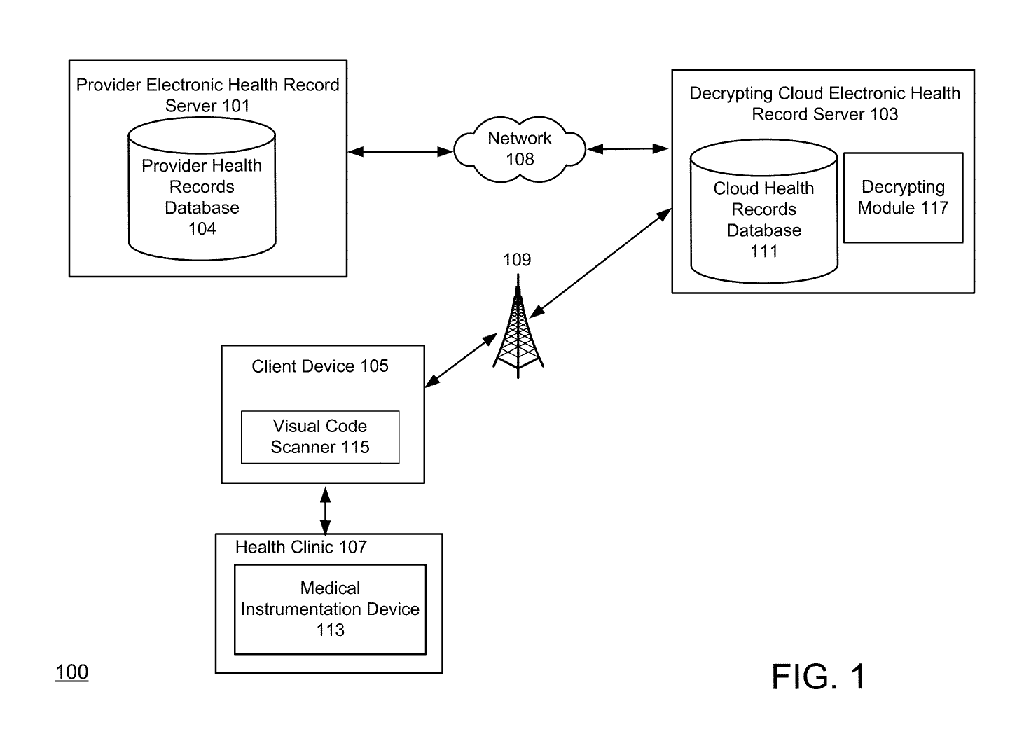

FIG. 1 illustrates a system architecture of a health record system 100 in accordance with one embodiment. In one embodiment, the health record system 100 utilizes a data transfer methodology for securely transmitting and storing medical test results of patients that avoids the use of complex IT environments that use network topologies requiring local IT support such as 802.11a/b/g/n wireless protocols (or similar) or Ethernet. Furthermore, the health record system 100 avoids the use of unsecured and often difficult to configure Bluetooth communication within the heath record system 100. By refraining from requiring the use of complex IT environments, the health record system 100 can be implemented in the challenged environments described above, thereby ensuring the privacy of the patients of the health clinics. As described below in more detail, the health record system 100 uses visual codes from which medical test results are extracted to securely transmit and store the medical test results.

FIG. 1 illustrates a health record system 100 according to one embodiment. The health record system 100 includes a provider electronic health record (EHR) server 101, a decrypting cloud electronic health record (EHR) server 103, a client device 105, and a health clinic 107. As shown in FIG. 1, the provider EHR server 101 and the decrypting cloud EHR server 103 are in communication with each other via network 108. The network 108 may be the Internet or any combination of a local area network (LAN), a metropolitan area network (MAN), a wide area network (WAN), a mobile, wired or wireless network, a private network, or a virtual private network. In one embodiment, the client device 105 is in communication with the cloud EHR server 103 via a cellular connection 109 rather than the network 108. Some embodiments of the health record system 100 can have different or additional components than those described herein.

As shown in FIG. 1, the health record system 100 includes a provider electronic health record (EHR) server 101. The provider EHR server 101 stores electronic health records of patients of a health clinic 107 in a provider health records database 104. An electronic health record is a collection of electronic information or data related to the health of a patient. The electronic health record of a patient may refer to patient information, medical information, and/or financial information of the patient.

Examples of patient information include, but are not limited to, the name of the patient, address of the patient, phone number of the patient, date of birth of the patient, a unique patient identifier, medical history of family members of the patient, and a social security number of the patient. Examples of medical information of the patient include, but are not limited to, the name of the health clinic, address of the health clinic, notes entered by the patient's physician, medical test results, x-rays, prescribed medications, and services provided by the health clinic. Examples of patient financial information include, but are not limited to, billing information, insurance information, payment information, transaction history, etc. Employees such as physicians of the health clinic 107 may access medical records stored by the provider EHR server 101 via a secure web page provided by the provider EHR server 101 when client devices of the employees have network connectivity that allow connection to the provider EHR server 101.

The health record system 100 also includes a decrypting cloud electronic health record server 103. As described below, the decrypting cloud electronic health record server 103 receives from client device 105 encrypted test results of medical tests performed on patients at the health clinic 107. In one embodiment, the decrypting cloud electronic health record server 103 includes a decrypting module 117 that decrypts encrypted medical test data received from the client device 105 and, optionally, persistently stores the decrypted test data in the cloud health records database 111. Alternatively, the decrypting module 117 extracts medical test data from visual codes received from client device 105 as will be further described below.

In one embodiment, the decrypting cloud EHR server 103 transmits test data of patients stored in the cloud health records database 111 for storage in the provider health records database 104 of the provider EHR server 101 via the network 108. In one embodiment, the decrypting cloud EHR server 103 does not persistently store test results. The decrypting cloud EHR server 103 may temporarily store test results for a period of time before the test results are deleted from the cloud health records database 111. Some embodiments of the decrypting cloud EHR server 103 have different modules than those described here. Similarly, the functions can be distributed among the modules in a different manner than is described here. As used herein, the term “module” refers to computer program logic used to provide the specified functionality. Thus, a module can be implemented in hardware, firmware, and/or software.

The cloud health records database 111 of the decrypting cloud EHR server 103 may store similar information as the provider health records database 104 of the provider EHR 101 described above. However, the health records stored in the provider health records database 104 may be formatted according to the technology used to implement the provider EHR server 101 which may be different than the format of the health records stored in the cloud health records database 111 of the decrypting cloud EHR server 103.

As shown in FIG. 1, the health record system 100 also includes a health clinic 107. The health clinic 107 is a location where health services are provided by a health care provider such as a physician, nurse, physician's assistant, public health care worker, pharmacist, and/or lab technician, for example. Examples of a health clinic 107 include a hospital, physician's office, a pharmacy, a public health clinic, a mobile health testing facility, a mass testing “fair” located at a school, and a business or another other location where health services are provided. Generally, a health clinic 107 is any facility where patients are being treated that lacks a complex IT network required to securely transmit and store test data of medical tests.

The health clinic 107 includes a medical instrumentation device 113. The medical instrumentation device 113 is used to aid in the diagnosis, monitoring, and/or treatment of medical conditions of patients of the health clinic 107. Generally, the medical instrumentation device 113 is used by personnel at the health clinic 107 to perform a medical test associated with the medical instrumentation device on a patient or patient sample. For example, a glucose meter is a medical instrumentation device that is used to determine the approximate concentration of glucose in a patient's blood. Other examples of medical instrumentation devices 113 include a blood pressure monitor, a cholesterol analyzer, etc. While only a single medical instrumentation device 113 is shown in FIG. 1, the health clinic 107 may include any number of medical instrumentation devices.

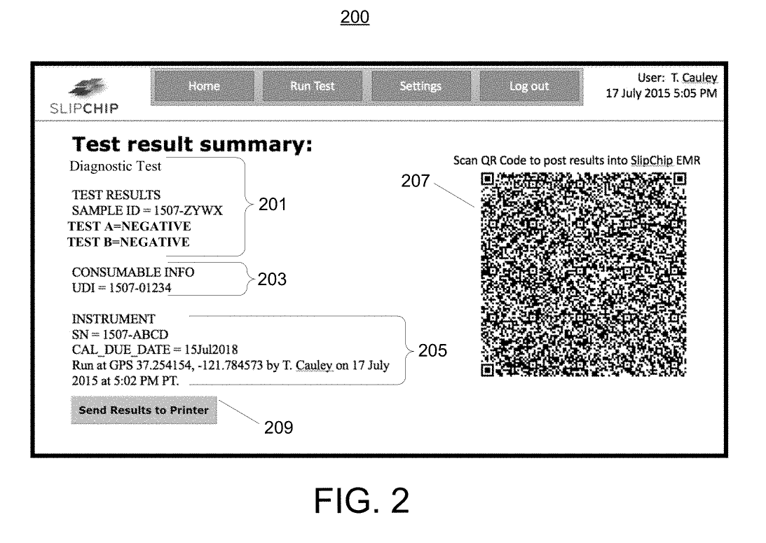

In one embodiment, the medical instrumentation device 113 includes a display screen that displays a test result summary of a medical test performed by the medical instrumentation device 113. FIG. 2 is an example of a test result summary 200 displayed on a display screen of the medical instrumentation device 113. The test result summary 200 includes information about the medical test (e.g., test information) 201 such as the type of medical test conducted by the medical instrumentation device 113, a sample identifier (ID) associated with the test (e.g., 1507-ZYWX), and the medical test results (e.g., Test A is negative and Test B is negative).

The test result summary 200 may also include a patient ID. In one embodiment, the name of the patient is unidentifiable from the patient ID displayed on the test result summary. Rather, the patient ID is the identifier used by the health clinic 107, provider EHR record server 101, and/or the decrypting cloud EHR server 103 to identify the patient. The name of the patient that is associated with the patient ID is only available on health records stored by the provider EHR server 101 and optionally the cloud EHR server 103 as described above.

In one embodiment, the medical instrumentation device 113 can be configured to display the patient's name on the display screen of the medical instrumentation device and/or the medical test results. For example, an administrator that has access (e.g., via a password or other authentication credentials) to control options of the medical instrumentation device 113 may configure the medical instrumentation 113 to display the patient's name on the display screen of the medical instrumentation device and/or the medical test results. The administrator may also configure the medical instrumentation device 113 to refrain from displaying the patient's name on the display screen of the medical instrumentation device 113 and/or the medical test results.

The test result summary 200 may also include information about the consumable (i.e. consumable information) 203 used in the medical test. A consumable is a medical product that functions as a receptacle for a sample from the patient (e.g., blood or urine) that will be used in the medical test. In one embodiment, the consumable information 203 includes a universal device identifier (UDI) of the consumable (e.g., 1507-01234). The UDI of the consumable is associated with information about the consumable such as a lot number that identifies a particular quantity or lot of material from the manufacturer of the consumable, an expiration date of the consumable, and/or any recalls associated with the consumable. The UDI may also be associated with other information.

In one embodiment, the UDI of a consumable is printed on the consumable. In addition to being printed on the UDI or instead of the UDI being printed on the consumable, the consumable includes a radio-frequency identification (RFID) tag or a visual code (e.g., a QR code) that comprises the UDI of the consumable. In one embodiment, the RFID tag may be scanned at the health clinic 107 prior to conducting a medical test. The RFID tag may be scanned by the medical instrumentation device 113 or another device at the health clinic 107. If the health clinic 107 has connectivity to the network 108, the UDI of the consumable is sent to the decrypting cloud EHR server 103 responsive to scanning the RFID tag using a device at the health clinic 107 such as the medical instrumentation device 113. Alternatively, if the health clinic 107 lacks connectivity to the network 107, the client device 105 may scan the RFID tag or the visual code on the consumable that contains the UDI of the consumable and transmits the UDI to the decrypting cloud EHR server 107.

The decrypting cloud EHR server 103 may provide any recall information associated with the consumable or indicate if the consumable is expired in response to receiving the UDI. The information provided by the decrypting cloud EHR server 103 allows the physician or medical technician performing the test to make a determination whether to use the consumable in the medical test. In an alternative embodiment, the UDI of the consumable is transmitted to another server that does not store the health records of patients such as a server associated with the manufacturer of the consumable. In response to receiving a UDI of a consumable, the server provides information associated with the consumable to the device that sent the UDI to the server.

The test result summary 200 may also include information about the medical instrumentation device 113 (i.e. medical instrumentation device information) 205. In one embodiment, the medical instrumentation device information 205 includes at least one of a serial number of the medical instrumentation device 113, a date that the medical instrumentation device 103 was last calibrated, geographical coordinates (e.g., latitude and longitude) of the medical instrumentation device 113 at the time the medical test was conducted, geographical coordinates associated with the medical instrumentation device 113 during a configuration of the medical instrumentation device 113, a name of the person that conducted the medical test using the medical instrumentation device 113, and a date and time that the medical instrumentation device 113 was used to complete the medical test. The medical instrumentation device information 205 may also include performance data of the device that are indicative of whether the device needs replacement or re-calibration. For example, the performance data may include statistics of results provided by the medical instrumentation device 113. The user of the medical instrumentation device 113 can determine whether the medical instrumentation device 113 requires recalibration or replacing based on the statistics.

In one embodiment, the test result summary 200 also includes a visual code 207 that comprises some or all of the data included in the test result summary 200. The visual code may be non-human decipherable such that it is impossible for a human to decipher the test data from merely looking at the visual code. The visual code may be a barcode such as a two-dimensional barcode (e.g., a Quick Response (QR) code) or a linear barcode. In one embodiment, the medical instrumentation device 113 encrypts the test data that comprises some or all of the data included in the test result summary 200 that is represented by the visual code prior to embedding the test data in the visual code. The medical instrumentation device 113 may use an encryption algorithm (e.g., 256 bit encryption) to encrypt the test data to which only the decrypting cloud EHR server 103 has the key to decrypt the test data. The visual code may also include test data that is unencrypted. Unencrypted test data included in the visual code is generally non-sensitive information such as a consumable expiration date and an identifier of the medical instrumentation device.

As shown in FIG. 1, the health clinic 107 is not directly coupled to the provider EHR server 101 via network 108. Thus, in some implementations, the medical instrumentation device 113 lacks the network connectivity that would allow the medical instrumentation device 113 to securely transmit test results to the provider EHR server 101. Alternatively, the medical instrumentation device 113 may lack connectivity to the network 108 at the time the medical test is being performed by the medical instrumentation device 113. Thus, the medical instrumentation device 113's connection to the network 108 is transient.

In one embodiment, the visual code shown in the test result summary 200 is used to upload the test data embedded in the visual code to the provider EHR server 101 in a secure manner. To upload the test data into the provider EHR server 101, in certain implementations, the medical instrumentation device 113 transmits the test data to a printer located within the health clinic 107 for printing on a printing medium such as paper. The medical instrumentation device 113 sends the test data to the printer for printing in response to receiving a selection of the print command 209 displayed on the medical instrumentation device 113. The medical instrumentation device 113 may print the test data if the medical instrumentation device 113 includes printing capabilities.

In one embodiment, the printed medical test data includes only the visual code 207 displayed on the test result summary 200. That is, the printed medical test data does not include the test information 201, the consumable information 203, and the instrument information 205 shown in the test result summary 200. By only including the visual code 207 in the printed test data, the results of the medical test are kept confidential as the results cannot be easily determined by simply looking at the visual code 207.

In an alternative embodiment, the visual code 207 is not printed. Rather, the visual code 207 is captured by the client device 105 directly from the display screen of the medical instrumentation device 113. For example, the visual code scanner 116 of the client device 107 is used to scan the visual code 207 directly from the medical instrumentation device 113.

Referring back to FIG. 1, the health record system 100 includes a client device 105. The client device 105 is used by a user to upload the test data to the decrypting cloud EHR server 103 using visual codes included in either the printed test data or the display screen of the medical instrumentation device 113. The user may be the physician or medical technician at the health clinic 107 for example.

Since the health clinic 107 may lack network connectivity to upload the test data, the visual code including the test data may be scanned by the client device 105 directly from the printed visual code or directly from the display screen of medical instrumentation devices 114. The client device 105 uploads the test data from the visual code to the decrypting cloud EHR server 103 once the client device 105 of the user is connected to the network 109. By utilizing the client device's own connection to the network 109 to upload test data, the health clinic 107 does not need to configure its own secure IT network to upload the test results to the EHR server 103.

In one embodiment, the client device 105 may lack connectivity to the network 109 at the time that the visual code is scanned such as at the health clinic 107. Thus, the client device 105 is unable to transmit the test data to the decrypting cloud EHR server 103 at the time the visual code is scanned by the client device 107. In one embodiment, the client device 105 is configured to automatically transmit the test data to the decrypting cloud EHR server 103 when the client device 105 has connectivity to the network 109. Alternatively, the client device 105 requires user permission to send the test data to the decrypting cloud EHR server 103 once connectivity to the network 109 is available.

In one embodiment, the client device 105 is an electronic device such as a mobile phone, a tablet, notebook, or desktop computer, or a personal digital assistant. While only a single client device 105 is shown in FIG. 1, any number of client devices 105 may be included in the health record system 100.

As shown in FIG. 1, the client device 105 includes a visual code scanner 115. The visual code scanner 115 scans visual codes that are included in printed medical test results. The visual code scanner 115 may scan a visual code by capturing a picture of the visual code using a camera included in the client device 105 or a camera connected to the client device 105 via a wired (e.g., a USB cable) or wireless (e.g., Bluetooth) connection mechanism. The visual code scanner 115 can also be used to scan visual codes from the test result summary displayed on the medical instrumentation device 113. An example of the visual code scanner 115 is a QR reader application stored on the client device 105. In another example, the visual code scanner 115 is a custom application used to scan visual codes rather than a generic QR reader application.

In one embodiment, the client device 105 transmits the test data that are embedded in the visual code 207 to the decrypting cloud EHR server 103 for processing and/or storage in the health records database 111 responsive to the visual code scanner 115 scanning the visual code 207. The visual code scanner 115 obtains the test data from the visual code 105 by extracting the encrypted test data from the visual patterns that are present in the visual code 207. The client device 105 transmits the extracted test data to decrypting cloud EHR server 103 for storage and/or processing via the network 109. As described above, the decrypting cloud EHR server 103 may send test results uploaded to the decrypting cloud EHR server 103 to the provider EHR server 101 for storage via network 108. In one embodiment, the test results sent to the provider EHR server 101 are encrypted by the decrypting cloud EHR server 103.

As mentioned above, the medical instrumentation device 113 may encrypt the test data included in the visual code. In some embodiments, the test data included in the visual code is not encrypted by the medical instrumentation device 113. Rather, the visual code scanner 115 encrypts the medical test data that are extracted from visual codes using an encryption technique. For example, the visual code scanner 115 may encrypt the medical test data using a 256 bit encryption. However, any encryption algorithm can be employed. By encrypting the medical test data, the medical test data are kept confidential in the scenario where the printed test data are obtained by unauthorized individuals that try to access the medical test data. Upon receipt of the encrypted test data, the decrypting module 117 decrypts the encrypted medical results in order for the medical results to be human readable.

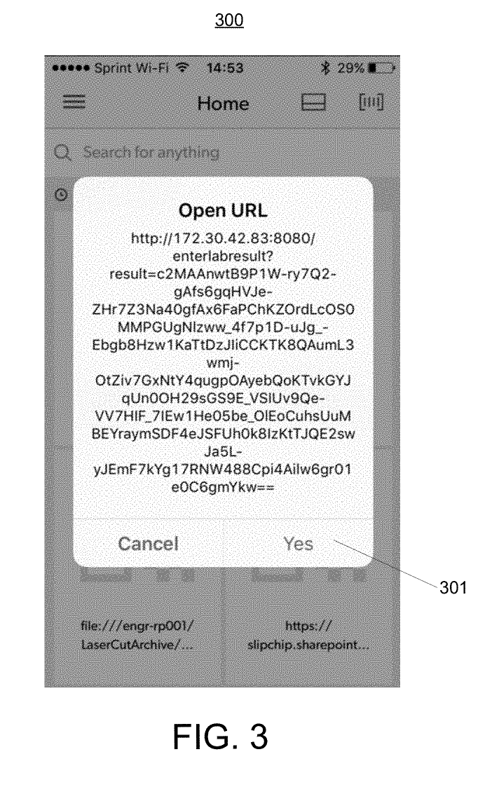

FIG. 3 illustrates a user interface 300 of the visual code scanner 115 executing on the client device 105 responsive to scanning a visual code. The user interface 300 displays the encrypted test data on the client device 105. As shown in FIG. 3, the encrypted medical test data can be included in a uniform resource locator (URL) that is non-human decipherable such that it is impossible for a human to decipher the encrypted medical test results into meaningful data. The URL links to the decrypting cloud EHR server 103. To access a human decipherable version of the encrypted test data, the user must log into the decrypting cloud EHR server 103. For example, user selection of the user interface element 301 (e.g., the “yes” button) to open the URL causes the client device 105 to be directed to the decrypting cloud EHR server 103.

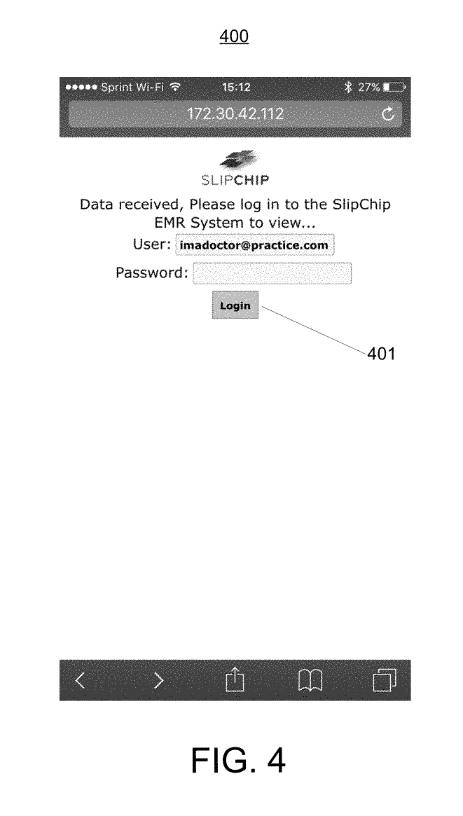

In one embodiment, the URL links to the test data stored by the decrypting cloud EHR server 103. However, the decrypting cloud EHR server 103 may employ security measures to prevent unauthorized access to the test data linked by the URL. For example, the client device 105 may display a login user interface 400 (e.g., a web page) of the decrypting cloud EHR server 103 shown in FIG. 4. The login user interface 400 requires security credentials such as a user name and password to access the medical test results. The client device 105 transmits the login credentials to the decrypting cloud EHR server 103 responsive to user selection of the login UI element 401.

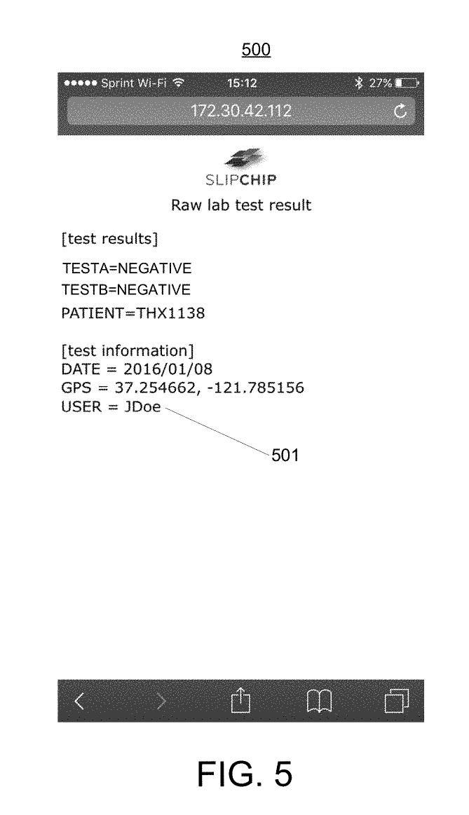

The decrypting cloud EHR server 103 receives the login credentials and identifies whether the received login credentials match login credentials stored at the decrypting cloud EHR server 103. If the login credentials are authenticated by the decrypting cloud EHR server 103, the client device 105 receives a human readable version of the test data linked by the visual code from the decrypting cloud EHR server 103. For example, FIG. 5 illustrates a user interface 500 of the test data that are displayed on the client device 105 after being authenticated by the decrypting cloud EHR server 103. The test data displayed on the client device 105 may include all of the information included in the test result summary 200 or a subset of the information. In addition, the test data displayed on the client device 105 may include the user name 501 of the user on the decrypting cloud EHR server 103.

In one embodiment, the decrypting cloud EHR server 103 sends a notification to the health care provider (e.g., the physician) responsible for the patient associated with the medical test data and/or to the patient if the decrypting cloud EHR server 103 fails to authenticate the login credentials due to an incorrect username and/or password. Thus, the decrypting cloud EHR server 103 warns the health care provider and/or patient of any failed attempts to access a patient's test results.

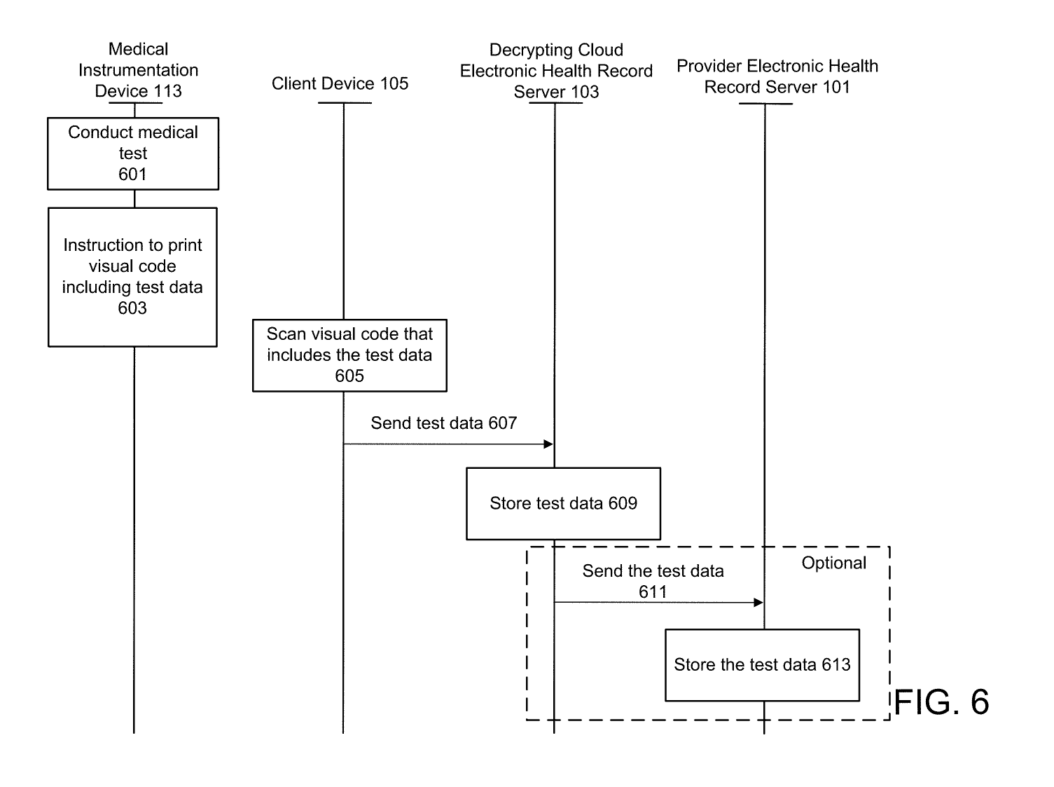

FIG. 6 is an interaction diagram describing a process for uploading medical test data of a patient to the decrypting cloud EHR server 103 according to one embodiment. Note that in other embodiments different steps or orders of steps may be implemented than those shown in FIG. 6.

In one embodiment, a medical instrumentation device 113 located at a health clinic 107 conducts 601 a medical test 601. For example, the medical instrumentation device 113 may measure the amount of glucose included in a patient's blood sample that is provided to the medical instrumentation device 113. The medical instrumentation device 113 sends an instruction 603 to a printer to print a visual code (e.g., a QR code) that includes test data associated with the medical test (e.g., the results of the medical test) that are embedded in the visual code. Alternatively, the medical instrumentation device 113 prints the visual code if the medical instrumentation device 113 includes printing capabilities. In yet another embodiment, the medical instrumentation device 113 displays the visual code on the display screen of the medical instrumentation device 113.

A client device 105 scans 605 the visual code that includes the test data. The client device 105 may use a visual code scanner 115 to scan the visual code. Responsive to scanning the visual code, the client device 105 sends 607 the test data to the decrypting cloud EHR server 103 via the cellular network 109. The decrypting cloud EHR server 103 stores test data 609. The cloud EHR server 103 may optionally send 611 some or all of the test data to the provider EHR server 101 via the network 108 that stores 613 the test data for the health clinic 107.

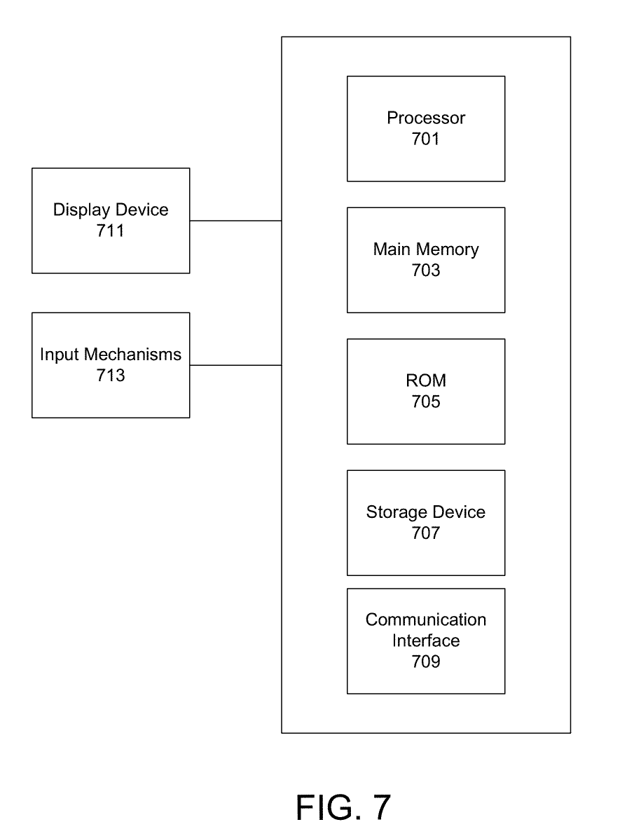

FIG. 7 is a diagram illustrating a computer system upon which embodiments described herein may be implemented. For example, in the context of FIG. 1, the provider EHR server 101, the decrypting cloud EHR server 103, client device 105, and medical instrumentation device 113 may be implemented using a computer system such as described by FIG. 7.

In one implementation, the provider EHR server 101, the decrypting cloud EHR server 103, client device 105, and medical instrumentation device 113 include processing resources 701, main memory 703, read only memory (ROM) 705, storage device 707, and a communication interface 709. The provider EHR server 101, the decrypting cloud EHR server 103, client device 105, and medical instrumentation device 113 include at least one processor 701 for processing information and a main memory 703, such as a random access memory (RAM) or other dynamic storage device, for storing information and instructions to be executed by one or more processors 701. Main memory 703 also may be used for storing temporary variables or other intermediate information during execution of instructions to be executed by processor 701. Provider EHR server 101, the decrypting cloud EHR server 103, client device 105, and medical instrumentation device 113 may also include ROM 705 or other static storage device for storing static information and instructions for processor 701. The storage device 707, such as a magnetic disk or optical disk, is provided for storing information and instructions.

The communication interface 709 can enable the provider EHR server 101, the decrypting cloud EHR server 103, client device 105, and medical instrumentation device 113 to communicate with one or more networks (e.g., cellular network) through use of the network link (wireless or wireline). Using the network link, the provider EHR server 101, the decrypting cloud EHR server 103, client device 105, and medical instrumentation device 113 can communicate with one or more computing devices, and one or more servers.

The provider EHR server 101, the decrypting cloud EHR server 103, client device 105, and medical instrumentation device 113 can also include a display device 711, such as a cathode ray tube (CRT), an LCD monitor, or a television set, for example, for displaying graphics and information to a user. An input mechanism 713, such as a keyboard that includes alphanumeric keys and other keys, can be coupled to the provider EHR server 101, the cloud EHR server 103, client device 105, and medical instrumentation device 113 for communicating information and command selections to processor 701. Other non-limiting, illustrative examples of input mechanisms 713 include a mouse, a trackball, touch-sensitive screen, or cursor direction keys for communicating direction information and command selections to processor 701 and for controlling cursor movement on display device 711.

Examples described herein are related to the use of the provider EHR server 101, the decrypting cloud EHR server 103, client device 105, and medical instrumentation device 113 for implementing the techniques described herein. According to one embodiment, those techniques are performed by the provider EHR server 101, the decrypting cloud EHR server 103, client device 105, and medical instrumentation device 113 in response to processor 701 executing one or more sequences of one or more instructions contained in main memory 703. Such instructions may be read into main memory 703 from another machine-readable medium, such as storage device 707. Execution of the sequences of instructions contained in main memory 703 causes processor 701 to perform the process steps described herein. In alternative implementations, hard-wired circuitry may be used in place of or in combination with software instructions to implement examples described herein. Thus, the examples described are not limited to any specific combination of hardware circuitry and software.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects disclosed herein include process steps and instructions described herein in the form of a method. It should be noted that the process steps and instructions described herein can be embodied in software, firmware or hardware, and when embodied in software, can be downloaded to reside on and be operated from different platforms used by a variety of operating systems.

The embodiments discussed above also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings described herein, and any references below to specific languages are provided for disclosure of enablement and best mode.

While the disclosure has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

We claim:

1. A computer-implemented method for storing results of a medical test, the method comprising:
scanning, using a client device that is capable of being connected to a network, a printed visual code that is not human-decipherable, the printed visual code having embedded therein encrypted test data relating to a medical test performed by a medical instrumentation device located at a health clinic;
extracting, by the client device, the encrypted test data from the printed visual code;
connecting via the client device to the network; and
sending, by the client device, the extracted encrypted test data to a decrypting cloud electronic health record server via the network.

2. The computer-implemented method of claim 1, wherein the network is comprised of one or more of the Internet, a LAN, a MAN , a WAN, a mobile network, a cellular network, a wired network, a wireless network, a private network, and a virtual private network.

3. The computer-implemented method of claim 1, wherein the network is a cellular network.

4. The computer-implemented method of claim 1, wherein the printed visual code further has embedded therein unencrypted data comprising a destination identifier.

5. The computer-implemented method of claim 3, wherein the destination identifier is a uniform resource locator (URL).

6. The computer-implemented method of claim 1, wherein the encrypted test data comprises test information.

7. The computer-implemented method of claim 6, wherein the encrypted test data further comprises at least one of consumable information, medical instrument device information, or a patient identifier.

8. The computer-implemented method of claim 1, wherein the decrypting cloud electronic health record server decrypts the test data that are embedded in the visual code and stores the decrypted test data.

9. The computer-implemented method of claim 1, wherein the medical instrumentation device lacks any connectivity to the network.

10. The computer-implemented method of claim 1, wherein the medical instrumentation device's connectivity to the network is transient and the medical instrumentation device lacks connectivity to the network at the time the medical test is performed.

11. The computer-implemented method of claim 1, wherein sending encrypted test data to the cloud electronic health record server comprises:
sending a uniform resource locator (URL) to the decrypting cloud electronic health record server, the URL including the encrypted test data.

12. The computer-implemented method of claim 8, further comprising:
receiving, on the client device, a request from a user of the client device to view the decrypted test data;
transmitting a request to the decrypting cloud electronic health record server for the decrypted test data responsive to receiving the request from the user;
receiving, from the decrypting cloud electronic health record server, a log-in user interface of the cloud electronic health record server;
transmitting login credentials of the user to the decrypting cloud electronic health record server;
responsive to the cloud electronic health record server authenticating the login credentials, receiving the decrypted test data from the decrypting cloud electronic health record server; and
displaying the decrypted test data on the client device.

13. The computer-implemented method of claim 1, wherein the encrypted test data include information about the medical test comprising a type of medical test performed by the medical instrumentation device and a patient identifier.

14. The computer-implemented method of claim 13, wherein a name of a patient is not ascertainable directly from the patient identifier.

15. The computer-implemented method of claim 7, wherein the consumable information comprises at least one of a lot number of the consumable and an expiration date of the consumable.

16. The computer-implemented method of claim 7, wherein medical instrumentation device information comprises at least one of a serial number of the medical instrumentation device, a date that the medical instrumentation device was last calibrated, geographical coordinates of the medical instrumentation device at a time that the medical test was conducted, geographical coordinates of the medical instrumentation device, a name of a person that conducted the medical test using the medical instrumentation device, and a date and time that the medical test was conducted using the medical instrumentation device.

17. The computer-implemented method of claim 1, wherein the decrypting cloud electronic health record server sends the encrypted test data to an electronic health record server of the health clinic, the electronic health record server of the health clinic being distinct from the cloud electronic health record server.

18. The computer-implemented method of claim 1, wherein the visual code is a Quick Response (QR) code.

19. The computer-implemented method of claim 1, wherein the printed visual code is printed on paper that includes only the printed visual code.

20. The computer-implemented method of claim 1, wherein the printed visual code is printed to a display screen on the medical instrumentation device.

21. A non-transitory computer readable storage medium storing executable code for storing results of a medical test, the code when executed by one or more computer processors causes the one or more computer processors to perform steps comprising:
scanning, using a client device that is capable of being connected to a network, a printed visual code that is not human-decipherable, the printed visual code having embedded therein encrypted test data relating to a medical test performed by a medical instrumentation device located at a health clinic;
extracting, by the client device, the encrypted test data from the printed visual code;
connecting via the client device to the network; and
sending, by the client device, the extracted encrypted test data to a decrypting cloud electronic health record server via the network.

22. The computer program product of claim 21, wherein the network is comprised of one or more of the Internet, a LAN, a MAN , a WAN, a mobile network, a cellular network, a wired network, a wireless network, a private network, and a virtual private network.

23. The computer program product of claim 21, wherein the network is a cellular network.

24. The computer program product of claim 21, wherein the printed visual code further has embedded therein unencrypted data comprising a destination identifier.

25. The computer program product of claim 24, wherein the destination identifier is a uniform resource locator (URL).

26. The computer program product of claim 21, wherein the encrypted test data comprises test information.

27. The computer program product of claim 26, wherein the encrypted test data further comprises at least one of consumable information, medical instrument device information, or a patient identifier.

28. The computer program product of claim 21, wherein the decrypting cloud electronic health record server decrypts the test data that are embedded in the visual code and stores the decrypted test data.

29. The computer program product of claim 21, wherein the medical instrumentation device lacks any connectivity to the network.

30. The computer program product of claim 21, wherein the medical instrumentation device's connectivity to the network is transient and the medical instrumentation device lacks connectivity to the network at the time the medical test is performed.

31. The computer program product of claim 21, wherein sending encrypted test data to the cloud electronic health record server comprises:
sending a uniform resource locator (URL) to the decrypting cloud electronic health record server, the URL including the encrypted test data.

32. The computer program product of claim 28, wherein the code when executed by the one or more computer processors further causes the one or more computer processors to perform further steps comprising:
receiving, on the client device, a request from a user of the client device to view the decrypted test data;
transmitting a request to the decrypting cloud electronic health record server for the decrypted test data responsive to receiving the request from the user;
receiving, from the decrypting cloud electronic health record server, a log-in user interface of the cloud electronic health record server;
transmitting login credentials of the user to the decrypting cloud electronic health record server;
responsive to the cloud electronic health record server authenticating the login credentials, receiving the decrypted test data from the decrypting cloud electronic health record server; and
displaying the decrypted test data on the client device.

33. The computer program product of claim 21, wherein the encrypted test data include information about the medical test comprising a type of medical test performed by the medical instrumentation device and a patient identifier.

34. The computer program product of claim 33, wherein a name of a patient is not ascertainable directly from the patient identifier.

35. A computer system for storing results of a medical test, the computer system comprising:
a decrypting cloud electronic health record server including a database that stores test data of medical tests; and
a client device capable of being connected to the cloud electronic health record server via a network, the client device configured to:
scan a printed visual code that is not human-decipherable, the printed visual code having embedded therein encrypted test data related to a medical test performed by a medical instrumentation device located at a health clinic;
extract the encrypted test data from the printed visual code;
connecting to the network; and
send the extracted encrypted test data to the decrypting cloud electronic health record server via the network.
